(19) United States
(12) Patent Application Publication
(10) Pub. No.: US 2021/0019677 A1
(43) Pub. Date: Jan. 21, 2021

(54) AUTOMATIC DETERMINATION OF OPTION DEFINING ATTRIBUTES

(71) Applicant: SAP SE, Walldorf (DE)

(72) Inventors: Mandar Sahani, Chandler, AZ (US); Rahul Yadav, Chandler, AZ (US); Jacob Stovall, Chandler, AZ (US)

(73) Assignee: SAP SE, Walldorf (DE)

(21) Appl. No.: 16/512,162

(22) Filed: Jul. 15, 2019

(51) Int. Cl. G06Q 10/06

(52) U.S. Cl. CPC G06Q 10/06315; G06F 3/0482; G06Q 10/06393

(57) ABSTRACT

Technologies are described for automatically determining option defining attributes for a category. For example, a user can select a category that is associated with a number of products, which are defined by product attributes. The user can also select a number of performance indicators. Based on the selections, the attributes that are most deterministic of the performance indicators can be identified using historical data and using information gain calculations. For example, the attributes can be ordered from most deterministic to least deterministic of the performance indicators.

### BACKGROUND

Retailers typically determine the types of products that will be sold in their stores in advance (e.g., a number of months or years in advance). For example, a typical retailer may plan the product choices or the types of products to be included in their product assortment a few months or years in advance of determining the actual products (the actual assortment plan) that will be used. There are several decisions that the retailer needs to make during this process. The decisions include the number of choices or types of products to sell, the grade of products to provide, and what brands, style, color, and size to include in the assortment. These decisions may need to be made in the context of a region (e.g., a geographical area) as well as the target customer audience.

When determining the types of products to include in their product assortments, retailers typically rely on a manual process that includes reviewing their product categories and determining which aspects of the products influence sales in a given region. The situation is further complicated when dealing with products that tend to change over time (e.g., in the fashion industry), which makes historical analysis difficult. For example, a product planner dealing with retail fashion products may have to utilize simple rules of brand, style, or color to determine the types of product choices to select for the product assortment. Using such rules of thumb can lead to poor decisions (e.g., decisions that are not optimal or that are not based on historical data).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various technologies are described herein for automatically determining option defining attributes for a category. For example, a user can select a category that is associated with a number of products, which are defined by product attributes. The user can also select a number of performance indicators. Based on the selections, the attributes that are most deterministic of the performance indicators can be identified using historical data and using information gain calculations. For example, the attributes can be ordered from most deterministic to least deterministic of the performance indicators.

For example, methods can be provided for automatically determining option defining attributes for a category. The method comprises receiving a selection of the category, where the category is associated with a plurality of product attributes, obtaining previous sales data for a plurality of products associated with the selected category, and receiving a selection of one or more performance indicators. The method further comprises determining which attributes, form the plurality of product attributes, are most deterministic of the one or more performance indicators based at least in part on the sales data, where the determining comprises performing an information gain calculation. The method further comprises outputting an indication of which attributes are the most deterministic of the one or more performance indicators for use as option defining attributes.

### BRIEF DESCRIPTION OF THE DRAWINGS

FIG. 1 is a diagram depicting an example option planning user interface for selecting performance indicators.

FIG. 2 is a diagram depicting an example graph of products ordered by weighted cumulative rank.

FIG. 3 is a diagram depicting an example option planning user interface depicting attributes that are ordered from most deterministic to least deterministic.

FIG. 4 is a flowchart of an example method for automatically determining option defining attributes for a category.

FIG. 5 is a flowchart of an example method for automatically determining option defining attributes for a category and ordering from most deterministic to least deterministic.

FIG. 6 is a flowchart of an example method for automatically determining option defining attributes for a category using an information gain calculation.

FIG. 7 is a diagram of an example computing system in which some described embodiments can be implemented.

FIG. 8 is an example cloud computing environment that can be used in conjunction with the technologies described herein.

### DETAILED DESCRIPTION

### Overview

The following description is directed to technologies for automatically determining option defining attributes for a category. For example, a user can select a category that is associated with a number of products, which are defined by product attributes. The user can also select a number of performance indicators. Based on the selections, the attributes that are most deterministic of the performance indicators can be identified using historical data and using information gain calculations. For example, the attributes can be ordered from most deterministic to least deterministic of one or more performance indicators (e.g., most deterministic of profit, revenue, etc.).

### Option Planning

Option planning refers to the selection of products (called product options or product choices) that will be sold by an organization (e.g., a business, such as a retailer). Option planning can be part of an overall retail planning process. The retail planning process can begin with a merchandise plan, which specifies the fiscal goals at a product category level. Location clustering can be employed to cluster sales locations (e.g., retail stores) into groups (e.g., by geographical area). Option planning can then be performed to identify product options. The process can continue with assortment planning (e.g., using the option planning results to determine the assortment of products), product listing and allocation, and finally product sales. The planning solutions can use historical sales data to help with analysis for the plan period. Depending on the business, the planning process can start a few years before the products appear in the store.

In some option planning solutions, a planner plans the product choices for each category by location cluster. Location clusters are based on the sales characteristics of one or more categories and are created by the planner. The planner further analyzes the sales trends for each cluster, category, and product choice to determine the kinds of products to keep for the plan period. These product choices are referred to as product options. Option planning provides a flexible means of defining product options by category, giving the planner a tool to refine and analyze sales trends by product options and location clusters.

One of the challenges faced by a planner is that the actual products change over time. For example, in the fashion industry, the actual products being sold change from season to season, and few products are carried across seasons. This makes historical analysis at the product level difficult. Trends can be summarized at the category level. For example, a planner can determine if the Men's Shirt category is performing between seasons and across years, but that does not always provide the necessary resolution for decision making (e.g., which specific brands, colors, styles, sizes, etc. to include in the product assortment).

The option planning process can address this issue by providing attribute-based option definition and analysis by category. The planner can then analyze the Men's Shirt category by the brand attribute while also analyzing the TV category by the resolution attribute. Such attributes that can then be used to define the option or choice for a category are referred to as option defining attributes in the option planning process. The planner can also control the way the option choice counts are computed. This is controlled by aggregation at the attribute level. For example, using an aggregation attribute of color for the category Men's Shirt with an option defining attribute of brand indicates that for each brand the planner wants to count the number of colors in the option planning process. In other words, for this example option planning is performed across brands by varying the number of colors. For example, a Men's Shirt category could include two brands, a first clothing manufacture and a second clothing manufacturer. The first clothing manufacturer could have two shirt colors, such as red and blue. The second clothing manufacturer could have three shirt colors, such as black, white, and red. In this example, the first clothing manufacturer would have an option count of two (two distinct shirt colors) and the second clothing manufacturer would have an option count of three (three distinct shirt colors). Option planning at this point in the planning cycle (e.g., 1 to 1.5 years out) does not typically reach the product level (e.g., specific products or SKUs, which in this example could be a specific shirt defined by size, color, brand, etc.).

An option plan can be created based on the selected categories and attributes. Location clusters can also be created based on sales analysis. The clusters can provide the regional context of the option plan. An option plan can then be created for the plan period and the categories and regions for planning can be identified. The planner can identify the options that are to be considered for the plan period for each category.

The actual choice counts for each product option are planned in a subsequent step of the option plan. The option definition and aggregation attributes are used to summarize the sales trends. The planner can then specify the option count for each product option defined by the option plan. The output of the option plan can then be used as a constraint in the assortment planning step to choose actual products.

### Automated Option Planning

The technologies described herein provide improvements to the manual option planning process. The improvements involve an automated, computer implemented, novel procedure that involves determining which attributes are most deterministic of product performance. In some implementations, the procedure involves ranking products based on one or more performance indicators (e.g., calculating cumulative weighted rankings). In some implementations, the procedure involves performing information gain calculations to order attributes from most deterministic to least deterministic.

The option planning technologies can provide a way to analyze historical sales to suggest option defining attributes for a given category. The option defining attributes provide a basis to optimize the product mix to better align with sales trends and strategy.

In previous option planning solutions, the process of selecting the option defining attributes and the aggregation attributes was a manual process. For example, a planner would select option defining attributes based on experience or review of historical data. However, there are a number of problems with this type of manual process. For example, the planner may not know which option defining attribute or attributes have the most influence on the desired result (e.g., maximizing profit). The planner may also not have the ability to effectively analyze the historical data.

As describe above regarding the manual option planning process, the planner can specify option defining attributes for a category as a manual process. However, the actual attributes that affect sales (e.g., that most affect sales) may not be obvious to the planner For example, the planner may not be able to determine whether brand or color most affects sales. When the planner makes an incorrect assumption about which attribute (or attributes) most affected sales performance the result may be a less optimal product decision for future product selection. The planner may tend to keep the same product options across seasons or years instead of re-evaluating the relevance of the attribute to the sales performance.

With the automated procedure, the most deterministic attributes can be automatically determined. A deterministic attribute means that the attribute distinguishes between high performing and low performing products, depending on which performance indicator, or performance indicators, are being considered.

After the most deterministic attributes are determined (e.g., presented as an ordered list), the user can make a selection of one or more of them. Using the selected attributes, the application can present the user with a number of product segments that are defined by the selected attributes. Option counts can then be determined for each product segment. For example, the user can adjust option counts for each product segment. Based on the option counts, sales targets can be evaluated.

### Selection of Performance Indicators

In the technologies described herein, performance indicators can be selected as part of the process of automatically determining option defining attributes. A performance indicator (also referred to as a key performance indicator (KPI)) refers to a measurable aspect of a business. Example performance indicators include revenue, profit, sales unit (quantity of products sold), and sales cost. The technologies described herein is not limited to these example performance indicators, and other performance indicators can be used in addition to, or instead of, these examples.

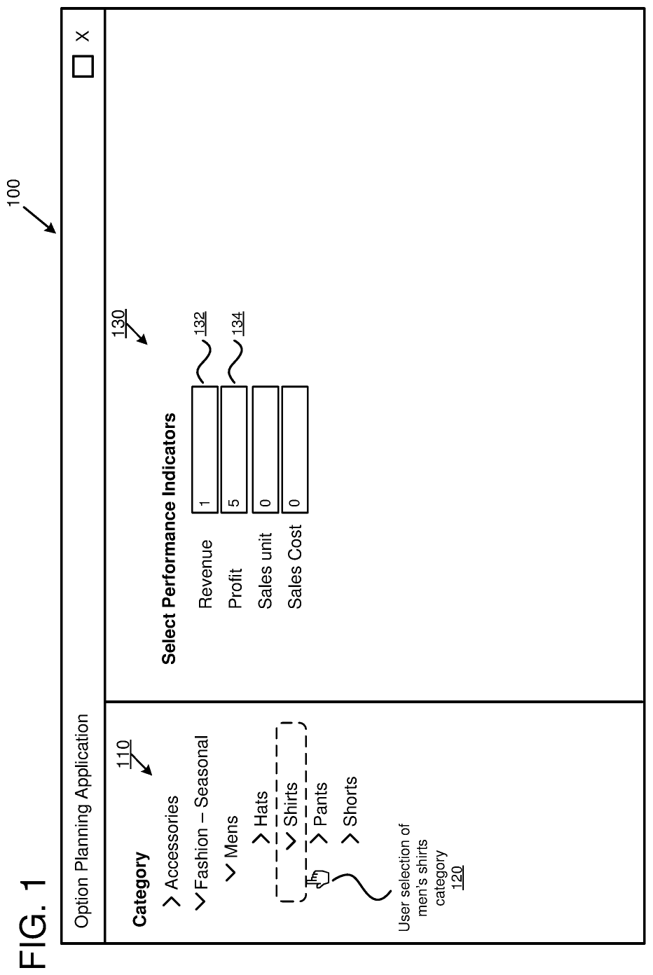

FIG. 1 is a diagram depicting an example option planning user interface 100 for selecting performance indicators. The example option planning user interface 100 is a graphical user interface (GUI). The example option planning user interface 100 can be part of an option planning application that is used as part of a planning process to select products (e.g., product options and product counts) for a plan period (e.g., for a future season or year).

Depicted at 110 is a category selection user interface area. The category selection user interface area allows the user to select the product category that will be used for the option planning process. In this example, the user has selected the men's shirts product category, as indicated by the selection depicted at 120. The selected product category is associated with a plurality of attributes of the products in the category (also referred to as product attributes). For example, the men's shirts category can be associated with attributes including brand, color, size, style, etc. Each category can be associated with its own set of attributes.

Depicted at 130 is a user interface area for selecting performance indicators. In this area, the user selects the performance indicators that the user is focusing on for the option planning process. The user can select one performance indictor or multiple performance indicators. The selected performance indicators will be used later when determining which attributes most influence the selected performance indicators. In this example, the user has selected the revenue performance indicator, as depicted at 132, and the profit performance indicator, as depicted at 134. The user has not selected the sales unit or sales cost performance indicators. This example user interface area utilizes fields where the user can enter a value (e.g., a positive value indicates that the performance indicator is selected, and a zero value indicates that the performance indicator is not selected). Other selection techniques can be used as well, such as check boxes, buttons, and/or other types of user interface selection elements.

In some implementations, the user can weight the performance indicators. In this example, the user has given the revenue performance indicator a weight value of 1, as depicted at 132. The user has given the profit performance indicator a weight value of 5, as depicted at 134. The weight values indicate the relative importance of the performance indicators. For example, in this situation the profit performance indicator, with a weight value of 5, will have more influence on the cumulative weighted ranking of the products than the revenue performance indicator, as will be seen in later examples. In some implementations, the user selects the desired performance indicator or performance indicators without entering a weight value (e.g., the performance indicators can all be weighted the same).

### Ranking of Products

Once the category has been selected, the products that are associated with the selected category can be ranked based on previous (e.g., historical) sales data. For example, the previous sales data can include sales for the products over a previous number of months, years, or some other time period.

The following table, Table 1, illustrates ranking of an example set of eight products (product A through product H) in the men's shirts category. The example eight products are ranked according to a revenue performance indicator and a profit performance indicator.

TABLE 1

| Product | Sum of Profit | Profit Rank | Sum of Revenue | Revenue Rank |
|---|---|---|---|---|
| Product A | $760 | 1 | $2,800 | 1 |
| Product E | $1,059 | 2 | $4,335 | 5 |
| Product C | $1,170 | 3 | $3,125 | 2 |
| Product D | $1,510 | 4 | $3,550 | 3 |
| Product B | $1,682 | 5 | $3,730 | 4 |
| Product H | $1,950 | 6 | $4,450 | 6 |
| Product G | $2,175 | 7 | $4,500 | 7 |
| Product F | $3,808 | 8 | $6,970 | 8 |

As depicted in Table 1 above, the eight products are ranked according to the sum of profit over the previous time period (e.g., the last three months), from lowest profit (ranked 1) to highest profit (ranked 8). The eight products are also ranked according to the sum of revenue over the previous time period (e.g., the last three months), from lowest profit (ranked 1) to highest profit (ranked 8).

Each of the eight products represents a specific product with its own attribute values. In this example, the products are associated with three attributes: brand, color, and size. For example, product H could be a Nike® brand shirt that is blue in color and size large, product G could be an Adidas® brand shirt that is red in color and size medium, product F could be a Nike brand shirt that is blue in color and size medium, and so on. In general, any number of products can be ranked in this manner for each of a number of performance indicators, and where the products are associated with any number of attributes.

In some implementations, a weighted cumulative rank is determined for each of the products based on the individual rankings and the weight values. The weighted cumulative rank is determined using the following equation, Equation 1. In Equation 1, the PIs are the one or more performance indicators, weight is the weight values, and rank is the relative rankings of for each product.

Cumulative Rank=Σ_{{k∈PIs}}weight(k)*rank(k) (Equation 1)

Continuing with the example that uses the eight products, two performance indicators (revenue, with a weight value of 1, and profit, with a weight value of 5), and the rankings depicted in Table 1, the following weighted cumulative values would be calculated:

Product A=profit (5*1)+revenue (1*1)=6

Product B=profit (5*5)+revenue (1*4)=29

Product C=profit (5*3)+revenue (1*2)=17

Product D=profit (5*4)+revenue (1*3)=23

Product E=profit (5*2)+revenue (1*5)=15

Product F=profit (5*8)+revenue (1*8)=48

Product G=profit (5*7)+revenue (1*7)=42

Product H=profit (5*6)+revenue (1*6)=36

The eight products can then be ordered by their weighted cumulative values. In this example, product F would be ranked highest (assigned a weighted cumulative rank of 8) and product A would be ranked lowest (assigned a weighted cumulative rank of 1).

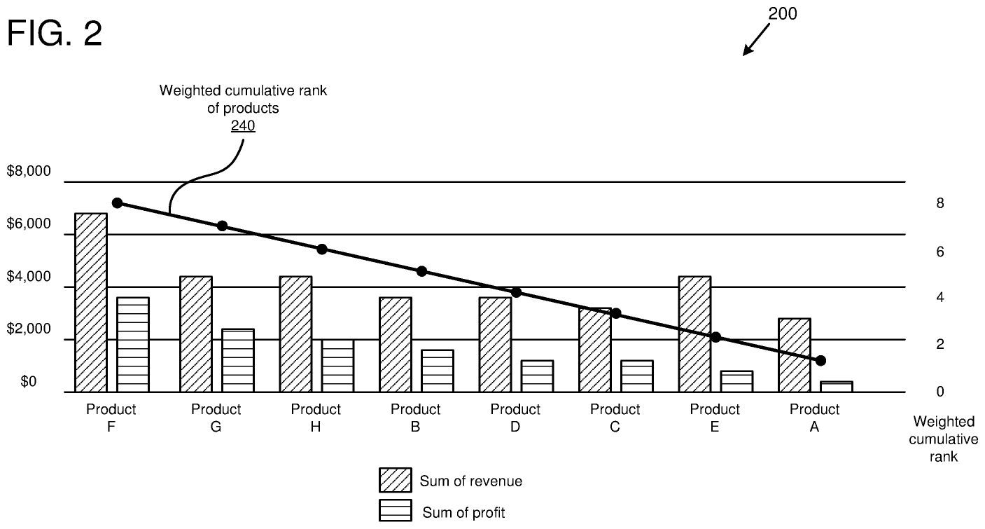

FIG. 2 is a diagram depicting an example graph 200 of products ordered by weighted cumulative rank. The depicted products are products A through H from the above example. Each product is depicted along with its sum of revenue and sum of profit (according to the values from Table 1). The depicted products in the example graph 200 are ordered according to their weighted cumulative rank, as depicted at 240.

### Information Gain

In the technologies described herein, information gain techniques can be applied to determine which attribute or attributes are most deterministic of the selected performance indicator or performance indicators. In some implementations, the information gain calculation uses Gini impurity and Gini gain (e.g., to order the products from most deterministic to least deterministic). In some implementations, an entropy technique is used to make the determination. Other techniques can also be used (e.g., other decision tree learning techniques) to determine which attributes have the most influence on the performance indicators.

As part of the information gain calculation, the ranked products (e.g., ordered by weighted cumulative rank) are classified into two (or more) groups. In some implementations, the classification is performed by identifying a threshold that is used to separate the ranked products into two groups. The threshold can be automatically determined (e.g., the middle of the ranked ranged) or selected by a user (e.g., the user can enter or select a threshold rank value).

Using the men's shirts category example, with the example eight products A through H, the user could select a threshold value of 4 for the classification. As a result, products with a weighted cumulative rank above 4 would be classified into a first group (in this example, a high performing group due to the high weighted cumulative rank values based on the revenue and profit performance indicators) and products with a weighted cumulative rank of 4 or below would be classified into a second group (in this example, a low performing group). With reference to FIG. 2, the high performing group would be the four products (product F, product G, product H, and product B) on the left-hand side of the chart, and the low performing group would be the four products (product D, product C, product E, and product A) on the right-hand side of the chart.

Once the products are classified into the two groups, the Gini gain can be calculated for each of the attributes. From the Gini gain, those attributes that are most deterministic can be identified. For example, the attributes can be ordered from most deterministic to least deterministic. An indication of which attributes are most deterministic can be presented. For example, the attributes can be presented in an order from most deterministic to least deterministic. A user can select one or more of the attributes (e.g., the most deterministic attribute or attributes) for use in the option planning process. Continuing with the men's shirts category example, the Gini gain is calculated for the three attributes associated with the category (brand, color, and size). As discussed further below, the Gini gain is calculated to be:
Brand, 0.125
Size, 0.045
Color, 0.000
   Based on the Gini gain values, brand would be the most deterministic attribute (the attribute that is most deterministic of the classification of the products into low and high performing products, which is ultimately based on the revenue and profit performance indicators), size would be the second most deterministic attribute, and color would be the least deterministic attribute. Therefore, if the user wanted to more easily find product choices that could maximize profit, and to a lesser extent revenue, then the user could select the brand attribute as the option defining attribute. The user could also select a combination of attributes, such as brand and size, as the option defining attributes.

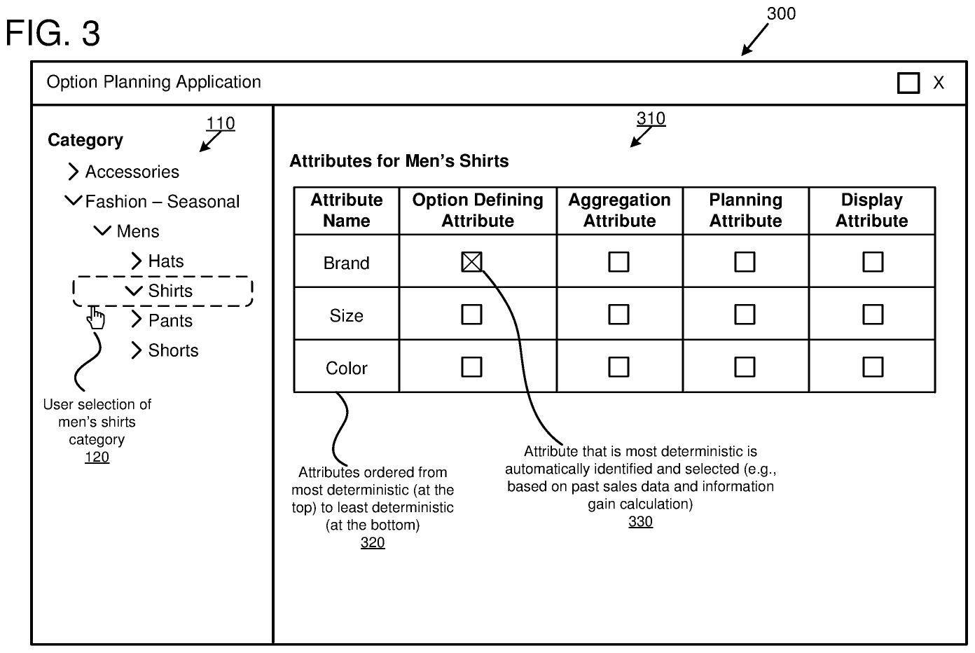

FIG. 3 is a diagram depicting an example option planning user interface 300 depicting attributes that are ordered from most deterministic to least deterministic. The attributes are the three attributes from the men's shirts category example. Because the brand attribute has the highest Gini gain (with a value of 0.125), it is ordered first as most deterministic, followed by size and color, as depicted at 320. Using this graphical user interface, the user can select which attributes to use as option defining attributes. In the example option planning user interface 300, the brand attribute has been selected, as depicted at 330. However, the user can choose a different attribute, or multiple attributes, to use as the option defining attributes.

The selected option defining attribute(s) can be used in option-based performance analysis. For example, the user could select an option defining attribute and view performance in the selected category from that point of view. The user could vary option counts to adjust performance within the category and region to optimize various performance indicators (e.g., to maximize profit or revenue).

### Example Information Gain Calculation

This section describes the example information gain calculation for calculating the Gini gain for the brand, color, and size attributes used in the men's shirts category example. For the example calculations, the products have the following attribute values for brand, size, and color.
Product A: Adidas, small, red
Product B: Nike, small, red
Product C: Adidas, large, blue
Product D: Nike, large, red
Product E: Adidas, medium, blue
Product F: Nike, medium, blue
Product G: Adidas, medium, red
Product H: Nike, large, blue

First, the Gini impurity is calculated, as depicted in Table 2, based on the high and low performing groups. As a result, the base Gini impurity is calculated to be is 0.50.

TABLE 2

| Performance | Count of | Probability of haying | |
|---|---|---|---|
| Group | Products | product in group | Probability |
| High | 4 | 4/8 = 0.5 | (0.5)² = 0.25 |
| Low | 4 | 4/8 = 0.5 | (0.5)² = 0.25 |

| | | |
|---|---|---|
| Total | 8 | Gini impurity: 1-(0.25 + 0.25) = 0.50 |

In the next step, Gini gain is calculated for each attribute. The Gini gain is calculated according to the following equation, Equation 2. A is the set of subsets within a given split, and J is the entire data set. In this example, the full set of products, J, is the list of products in Table 1. The cardinality of this set, |J|, is 8.

$${G}_{g g} ( J , A ) = {I}_{g} ( J ) - {\sum }_{a ⋐ A} \frac{\vert a \vert}{\vert J \vert} {I}_{g} ( a ) \qquad ( Equation 2 )$$

The attributes, color, size, and brand, each represent a way to split the products. They can be used to create subsets of high performing and low performing products.

Gini gain is the decrease in Gini impurity of the performance-category classification achieved by splitting the dataset by the attribute's values into subsets. The Gini impurity for each of these subsets is computed. Gini impurity is calculated using Equation 3 below.

I_{g}(p)=1−Σᵢ₌₁^{j}pᵢ² (Equation 3)

The weighted sum of the Gini impurity for each subset is then subtracted from the Gini impurity of the performance-category classification. The attribute with the most Gini gain should be considered as the most deterministic attribute for performance-category classification. This process is described below.

The Gini impurity calculation for the color attribute is depicted in Table 3 below. The color attribute has two possible values, blue and red.

TABLE 3

| | | | | | | Sum of | |
|---|---|---|---|---|---|---|---|
| | | | | Probability | Probability | prob- | Gini |
| Color | High | Low | Total | for high | for low | ability | impurity |
| Blue | 2 | 2 | 4 | 2/4 = 0.5 | 2/4 = 0.5 | (0.5)² + | I_{g}(Blue) = |
| | | | | | | (0.5)² = | 1 − 0.5 = |
| | | | | | | 0.5 | 0.5 |
| Red | 2 | 2 | 4 | 2/4 = 0.5 | 2/4 = 0.5 | (0.5)² + | I_{g}(Red) = |
| | | | | | | (0.5)² = | 1 − 0.5 = |
| | | | | | | 0.5 | 0.5 |

| | |
|---|---|
| Cardinality | 8 |

The Gini gain for the color attribute would then be calculated as follows.

G_{gg}(Color)=0.5−[((4/8)*0.5)+((4/8)*0.5)]=0.00

A value of zero indicates that using the color values for creating product subsets does not improve the Gini impurity for the color performance-category classification.

The Gini impurity calculation for the size attribute is depicted in Table 4 below. The size attribute has three possible values, large (L), medium (M), and small (S).

TABLE 4

| | | | | Probability | Probability | Sum of | Gini |
|---|---|---|---|---|---|---|---|
| Size | High | Low | Total | for high | for low | probability | impurity |
| L | 1 | 2 | 3 | ⅓ = 0.33 | ⅔ = 0.67 | (0.33)² + | I_{g}(L) = |
| | | | | | | (0.67)² = | 1 − 0.56 = |
| | | | | | | 0.56 | 0.44 |
| M | 2 | 1 | 3 | ⅔ = 0.67 | ⅓ = 0.33 | (0.67)² + | I_{g}(M) = |
| | | | | | | (0.33)² = | 1 − 0.56 = |
| | | | | | | 0.56 | 0.44 |
| S | 1 | 1 | 2 | ½ = 0.50 | ½ = 0.50 | (0.50)² + | I_{g}(S) = |
| | | | | | | (0.50)² = | 1 − 0.50 = |
| | | | | | | 0.50 | 0.50 |

| | |
|---|---|
| Cardinality | 8 |

The Gini gain for the size attribute would then be calculated as follows.

G_{gg}(Size)=0.5−[((3/8)*0.44)+((3/8)*0.44)+((2/8)*0.50)]=0.045

The Gini impurity calculation for the brand attribute is depicted in Table 5 below. The brand attribute has two possible values, Nike, and Adidas.

TABLE 5

| | | | | Probability | Probability | Sum of | Gini |
|---|---|---|---|---|---|---|---|
| Size | High | Low | Total | for high | for low | probability | impurity |
| Adidas | 1 | 3 | 4 | ¼ = 0.25 | ¾ = 0.75 | (0.25)² + (0.75)² = | I_{g}(Adidas) = |
| | | | | | | 0.625 | 1 − 0.625 = |
| | | | | | | | 0.375 |
| Nike | 3 | 1 | 4 | ¾ = 0.75 | ¼ = 0.25 | (0.25)² + (0.75)² = | I_{g}(Nike) = |
| | | | | | | 0.625 | 1 − 0.625 = |
| | | | | | | | 0.375 |

| | |
|---|---|
| Cardinality | 8 |

The Gini gain for the brand attribute would then be calculated as follows.

G_{gg}(Brand)=0.5−[((4/8)*0.375)+((4/8)*0. 375)]=0.125

### Methods for Automatically Determining Option Defining Attributes

In the technologies described herein, methods can be provided for automatically determining option defining attributes for a category. For example, as part of an option planning process, a user can select a category (associated with products and product attributes) and desired performance indicators, and the system can automatically calculate which attributes are most deterministic of product performance The most deterministic attributes can then be used for future product planning. For example, using the most deterministic attributes, future product selection (e.g., the type products, number of product options, etc.) can be more accurately determined (e.g., to maximize performance according to various performance indicators). For example, if the brand attribute is the most deterministic of the profit performance indicator, then brand can be used when determining a future product mix (e.g., to decide how many brands to offer, which brands to offer, how many product options within each brand to offer, etc.).

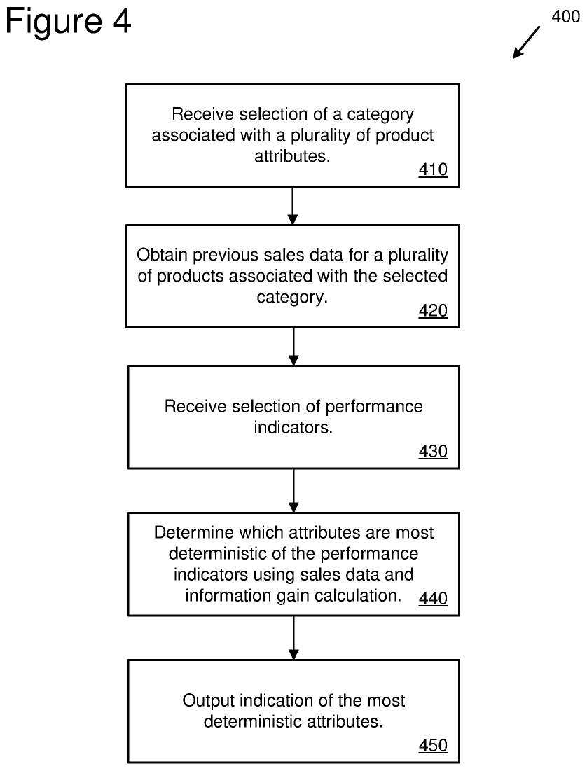

FIG. 4 is a flowchart of an example method 400 for automatically determining option defining attributes for a category. The example method 400 can be performed by software running on one or more computing devices. For example, the example method 400 can be performed by an option planning application (e.g., running as a cloud service).

At 410, a selection of a category is received. The category is associated with a plurality of attributes related to products (also referred to as product attributes). For example, if the selected category is men's shirts, then the products can be individual shirts (e.g., identified by attributes such as brand, size, color, price, style, etc.). The selection of the category can be received via a graphical user interface, such as the user interface depicted in FIG. 1.

At 420, previous sales data for the plurality of products is obtained. For example, the previous sales data can be historical sales data for a previous number of months or years.

At 430, a selection of one or more performance indicators is received. The selection can be received via a graphical user interface, such as the user interface depicted in FIG. 1.

At 440, the plurality of attributes are evaluated to determine which of the attributes are most deterministic of the one or more performance indicators. The determination is made based at least in part on the previous sales data. The determination can also involve an information gain calculation. For example, the plurality of products can be divided into two groups (e.g., a high performing group and a low performing group) based on the previous sales data and the performance indicators. A Gini impurity calculation can be performed to determine the base Gini impurity for the product split into the two groups. Gini gain can then be calculated for each of the attributes based on the base Gini impurity and the attribute, where the data set is split by the attribute's values into subsets. For example, if the attribute is color, then the Gini gain can indicate the decrease in Gini impurity of the high performing vs. low performing classification based on which blue color products are in the high group and which are in the low group, and which red products are in the high group and which are in the low group.

At 450, an indication of the most deterministic attributes is output. For example, the most deterministic attribute (or attributes) can be displayed to a user via a user interface. The attributes can be presented (e.g., ordered) from most deterministic to least deterministic. The attributes can then be available for selection as option defining attributes. The user interface depicted in FIG. 3 is one example of how the attributes can be presented and available for selection as option defining attributes.

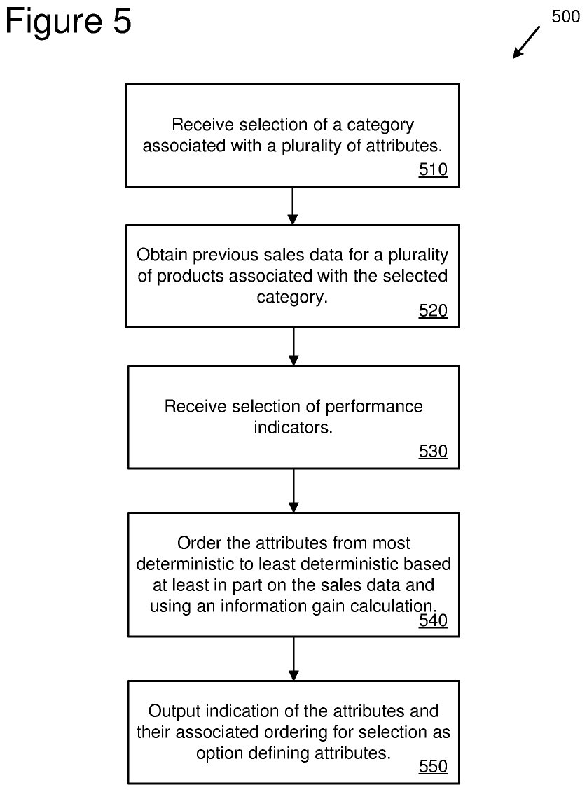

FIG. 5 is a flowchart of an example method 500 for automatically determining option defining attributes for a category and ordering from most deterministic to least deterministic. The example method 500 can be performed by software running on one or more computing devices. For example, the example method 500 can be performed by an option planning application (e.g., running as a cloud service).

At 510, a selection of a category is received. The category is associated with a plurality of attributes related to products (also referred to as product attributes). For example, if the selected category is men's shirts, then the products can be individual shirts (e.g., identified by attributes such as brand, size, color, price, style, etc.). The selection of the category can be received via a graphical user interface, such as the user interface depicted in FIG. 1.

At 520, previous sales data for the plurality of products is obtained. For example, the previous sales data can be historical sales data for a previous number of months or years.

At 530, a selection of one or more performance indicators is received. The selection can be received via a graphical user interface, such as the user interface depicted in FIG. 1.

At 540, the plurality of attributes are ordered from most deterministic to least deterministic based at least in part on the sales data and using an information gain calculation. For example, the plurality of products can be divided into two groups (e.g., a high performing group and a low performing group) based on the previous sales data and the performance indicators. A Gini impurity calculation can be performed to determine the base Gini impurity for the product split into the two groups. Gini gain can then be calculated for each of the attributes based on the base Gini impurity and the attribute, where the data set is split by the attribute's values into subsets. For example, if the attribute is color, then the Gini gain can indicate the decrease in Gini impurity of the high performing vs. low performing classification based on which blue color products are in the high group and which are in the low group, and which red products are in the high group and which are in the low group.

At 550, an indication of the attributes and their associated ordering is output for selection as option defining attributes. For example, the attributes can be output in an order from most deterministic to least deterministic. Or, the attributes can be output in another order and/or labeled. For example, the attributes can be associated with labels (e.g., graphical indications, numerical values, etc.) indicating their order (e.g., which is the most deterministic, which is the second most deterministic, and so on). The user interface depicted in FIG. 3 is one example of how the attributes can be presented as an ordered list and made available for selection as option defining attributes.

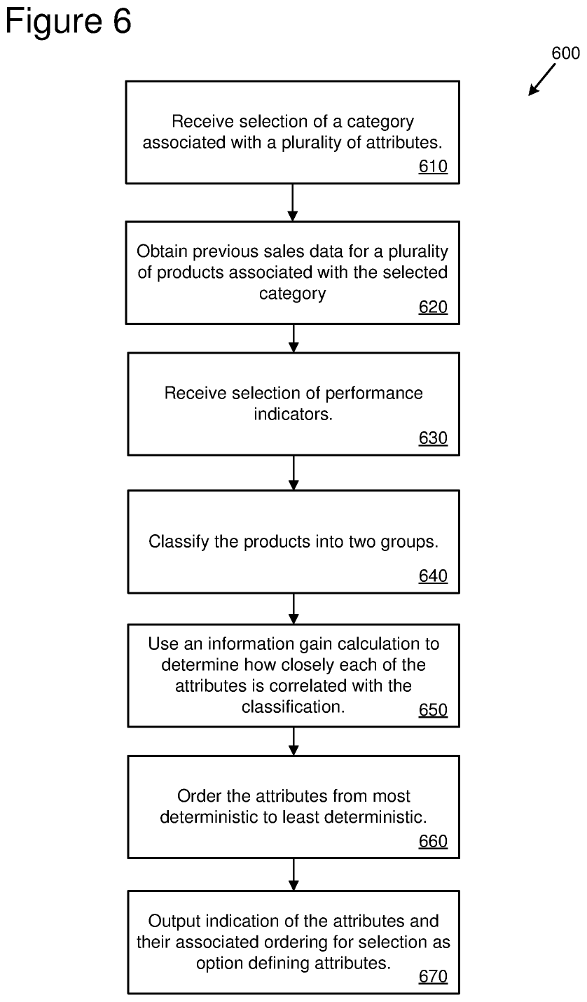

FIG. 6 is a flowchart of an example method 600 for automatically determining option defining attributes for a category using an information gain calculation. The example method 600 can be performed by software running on one or more computing devices. For example, the example method 600 can be performed by an option planning application (e.g., running as a cloud service).

At 610, a selection of a category is received. The category is associated with a plurality of attributes related to products (also referred to as product attributes). For example, if the selected category is men's shirts, then the products can be individual shirts (e.g., identified by attributes such as brand, size, color, price, style, etc.). The selection of the category can be received via a graphical user interface, such as the user interface depicted in FIG. 1.

At 620, previous sales data for the plurality of products is obtained. For example, the previous sales data can be historical sales data for a previous number of months or years.

At 630, a selection of one or more performance indicators is received. The selection can be received via a graphical user interface, such as the user interface depicted in FIG. 1.

At 640, the plurality of products are classified into two groups. For example, the plurality of products can be classified into a high performing group and a low performing group based on the previous sales data and the performance indicators.

At 650, an information gain calculation is used to determine how closely each of the attributes is correlated with the classification into the two groups, and ultimately with the performance indicators. For example, the information gain calculation can be used to determine which of the attributes are most deterministic and which are least deterministic. In some implementations, a Gini impurity calculation is performed to determine the base Gini impurity for the products that are split into the two groups. Gini gain is then calculated for each of the attributes based on the base Gini impurity and the attribute, where the data set is split by the attribute's values into subsets. For example, if the attribute is color, then the Gini gain can indicate the decrease in Gini impurity of the high performing vs. low performing classification based on which blue color products are in the high group and which are in the low group, and which red products are in the high group and which are in the low group.

At 660, the plurality of attributes are ordered from most deterministic to least deterministic. For example, the plurality of attributes can be ordered by their Gini gain values, from highest to lowest.

At 670, an indication of the attributes and their associated ordering is output for selection as option defining attributes. For example, the attributes can be output in an order from most deterministic to least deterministic. Or, the attributes can be output in another order and/or labeled. For example, the attributes can be associated with labels (e.g., graphical indications, numerical values, etc.) indicating their order (e.g., which is the most deterministic, which is the second most deterministic, and so on). The user interface depicted in FIG. 3 is one example of how the attributes can be presented as an ordered list and made available for selection as option defining attributes.

After the most deterministic attributes are determined (e.g., presented as an ordered list), the user can make a selection of one or more of them. For example, the attributes can be provided for selection as discussed above regarding 450, 550, and 670. Using the selected attributes, the application can present the user with a number of product segments that are defined by the selected attributes, such as products A through H discussed above. Option counts can then be determined for each product segment. For example, the user can adjust option counts for each product segment for a future planning period in order to evaluate the performance based on the selected attributes.

### Computing Systems

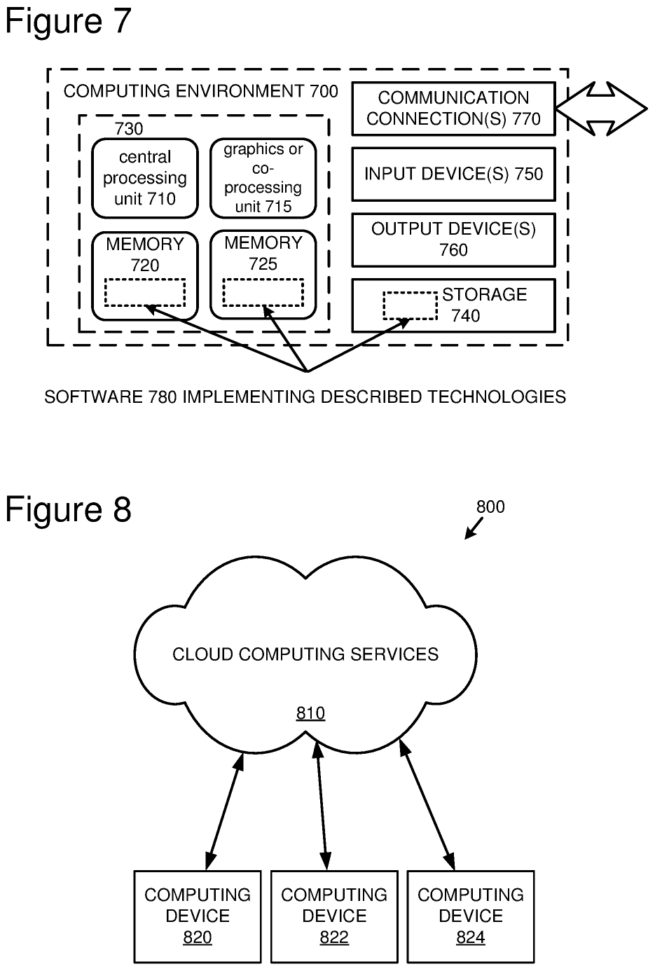

FIG. 7 depicts a generalized example of a suitable computing system 700 in which the described innovations may be implemented. The computing system 700 is not intended to suggest any limitation as to scope of use or functionality, as the innovations may be implemented in diverse general-purpose or special-purpose computing systems.

With reference to FIG. 7, the computing system 700 includes one or more processing units 710, 715 and memory 720, 725. In FIG. 7, this basic configuration 730 is included within a dashed line. The processing units 710, 715 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s). The memory 720, 725 stores software 780 implementing one or more innovations described herein, in the form of computer-executable instructions suitable for execution by the processing unit(s).

A computing system may have additional features. For example, the computing system 700 includes storage 740, one or more input devices 750, one or more output devices 760, and one or more communication connections 770. An interconnection mechanism (not shown) such as a bus, controller, or network interconnects the components of the computing system 700. Typically, operating system software (not shown) provides an operating environment for other software executing in the computing system 700, and coordinates activities of the components of the computing system 700.

The tangible storage 740 may be removable or non-removable, and includes magnetic disks, magnetic tapes or cassettes, CD-ROMs, DVDs, or any other medium which can be used to store information in a non-transitory way and which can be accessed within the computing system 700. The storage 740 stores instructions for the software 780 implementing one or more innovations described herein.

The input device(s) 750 may be a touch input device such as a keyboard, mouse, pen, or trackball, a voice input device, a scanning device, or another device that provides input to the computing system 700. For video encoding, the input device(s) 750 may be a camera, video card, TV tuner card, or similar device that accepts video input in analog or digital form, or a CD-ROM or CD-RW that reads video samples into the computing system 700. The output device(s) 760 may be a display, printer, speaker, CD-writer, or another device that provides output from the computing system 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Cloud Computing Environment

FIG. 8 depicts an example cloud computing environment 800 in which the described technologies can be implemented. The cloud computing environment 800 comprises cloud computing services 810. The cloud computing services 810 can comprise various types of cloud computing resources, such as computer servers, data storage repositories, database resources, networking resources, etc. The cloud computing services 810 can be centrally located (e.g., provided by a data center of a business or organization) or distributed (e.g., provided by various computing resources located at different locations, such as different data centers and/or located in different cities or countries).

The cloud computing services 810 are utilized by various types of computing devices (e.g., client computing devices), such as computing devices 820, 822, and 824. For example, the computing devices (e.g., 820, 822, and 824) can be computers (e.g., desktop or laptop computers), mobile devices (e.g., tablet computers or smart phones), or other types of computing devices. For example, the computing devices (e.g., 820, 822, and 824) can utilize the cloud computing services 810 to perform computing operators (e.g., data processing, data storage, and the like).

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (i.e., any available computing device, including smart phones or other mobile devices that include computing hardware). Computer-readable storage media are tangible media that can be accessed within a computing environment (one or more optical media discs such as DVD or CD, volatile memory (such as DRAM or SRAM), or nonvolatile memory (such as flash memory or hard drives)). By way of example and with reference to FIG. 7, computer-readable storage media include memory 720 and 725, and storage 740. The term computer-readable storage media does not include signals and carrier waves. In addition, the term computer-readable storage media does not include communication connections, such as 770.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A method, performed by one or more computing devices, for automatically determining option defining attributes for a category, the method comprising:
receiving a selection of the category, wherein the category is associated with a plurality of product attributes;
obtaining previous sales data for a plurality of products associated with the selected category;
receiving a selection of one or more performance indicators;
determining which attributes, form the plurality of product attributes, are most deterministic of the one or more performance indicators based at least in part on the sales data, wherein the determining comprises performing an information gain calculation; and
outputting an indication of which attributes are the most deterministic of the one or more performance indicators for use as option defining attributes.

2. The method of claim 1, wherein determining which attributes are most deterministic of the one or more performance indicators comprises:
classifying the plurality of products in the selected category into at least two groups;
using the information gain calculation to determine how closely each of the plurality of product attributes is correlated with the classification.

3. The method of claim 1, wherein the information gain calculation comprises:
calculating a base Gini impurity value; and
calculating a Gini gain for each of the plurality of attributes.

4. The method of claim 1, wherein determining which attributes are most deterministic of the one or more performance indicators comprises:
for each performance indicator of the one or more performance indicators:
ranking each product of the plurality of products based at least in part on the sales data;
classifying the plurality of products into two groups based at least in part on the ranking; and
using the information gain calculation to determine how closely each of the plurality of product attributes is correlated with the classification.

5. The method of claim 1, wherein determining which attributes are most deterministic of the one or more performance indicators comprises:
for each performance indicator of the one or more performance indicators:
ranking each product of the plurality of products based at least in part on the sales data;
obtaining weight values for each performance indicator;
calculating a weighted cumulative rank for each product of the plurality of products based on the ranking and the weight values;
classifying each of the plurality of products into either a high performing group or a low performing group based at least in part on the weighted cumulative ranks;
using the information gain calculation to determine how closely each of the plurality of attributes is correlated with the classification.

6. The method of claim 1, wherein determining which attributes are most deterministic of the one or more performance indicators comprises:
calculating a weighted cumulative rank for each product of the plurality of products based on relative rankings for each product within each performance indicator and weight values for each performance indicator.

7. The method of claim 6, wherein calculating the weighted cumulative rank for each product uses the following equation:
Cumulative Rank=Σ_{{k∈PIs}}weight(k)*rank(k)
wherein PIs are the one or more performance indicators, weight is the weight values, and rank is the relative rankings of for each product.

8. The method of claim 1, wherein determining which attributes are most deterministic of the one or more performance indicators comprises:
ordering the product attributes from most deterministic to least deterministic.

9. The method of claim 1, further comprising:
providing for display in an option planning user interface, the attributes that are determined to be the most deterministic of the performance indicators, wherein the displayed attributes are selectable as option defining attributes for option planning.

10. One or more computing devices comprising:
processors; and
memory;
the one or more computing devices configured, via computer-executable instructions, to perform operations for automatically determining option defining attributes for a category, the operations comprising:
receiving a selection of the category, wherein the category is associated with a plurality of attributes;
obtaining previous sales data for a plurality of products associated with the selected category;
receiving a selection of one or more performance indicators;
ordering the attributes from most deterministic of the one or performance indicators to least deterministic of the one or more performance indicators based at least in part on the sales data, wherein the ordering is performed using an information gain calculation; and
outputting an indication of the attributes and their associated ordering for selection as option defining attributes.

11. The one or more computing devices of claim 10, wherein ordering the attributes from most deterministic to least deterministic of the one or more performance indicators comprises:
classifying the plurality of products in the selected category into at least two groups;
using the information gain calculation to determine how closely each of the plurality of attributes is correlated with the classification.

12. The one or more computing devices of claim 10, wherein the information gain calculation comprises:
calculating a base Gini impurity value; and
calculating a Gini gain for each of the plurality of attributes.

13. The one or more computing devices of claim 10, wherein ordering the attributes from most deterministic to least deterministic of the one or more performance indicators comprises:
for each performance indicator of the one or more performance indicators:
ranking each product of the plurality of products based at least in part on the sales data;
classifying the plurality of products into two groups based at least in part on the ranking;
using the information gain calculation to determine how closely each of the plurality of attributes is correlated with the classification.

14. The one or more computing devices of claim 10, wherein ordering the attributes from most deterministic to least deterministic of the one or more performance indicators comprises:
for each performance indicator of the one or more performance indicators:
ranking each product of the plurality of products based at least in part on the sales data;
obtaining weight values for each performance indicator;
calculating a weighted cumulative rank for each product of the plurality of products based on the ranking and the weight values;
classifying each of the plurality of products into either a high performing group or a low performing group based at least in part on the weighted cumulative ranks;
using the information gain calculation to determine how closely each of the plurality of attributes is correlated with the classification.

15. The one or more computing devices of claim 10, wherein ordering the attributes from most deterministic to least deterministic of the one or more performance indicators comprises:
calculating a weighted cumulative rank for each product of the plurality of products based on relative rankings for each product within each performance indicator and weight values for each performance indicator.

16. The one or more computing devices of claim 10, wherein outputting an indication of the attributes and their associated ordering for selection as option defining attributes comprises:
providing for display, in an option planning user interface, the attributes ordered from most deterministic to least deterministic, wherein the displayed attributes are selectable as option defining attributes for option planning

17. One or more computer-readable storage media storing computer-executable instructions for automatically determining option defining attributes for a category, the operations comprising:
receiving a selection of the category, wherein the category is associated with a plurality of attributes;
obtaining previous sales data for a plurality of products associated with the selected category;
receiving a selection of one or more performance indicators;
classifying the plurality of products in the selected category into two groups based at least in part on the sales data;
using an information gain calculation to determine how closely each of the plurality of attributes is correlated with the classification into the two groups;
based at least in part on results of the information gain calculation, ordering the attributes from most deterministic of the one or performance indicators to least deterministic of the one or more performance indicators; and
outputting an indication of the attributes and their associated ordering for selection as option defining attributes.

18. The one or more computer-readable storage media of claim 17, wherein the information gain calculation comprises:
calculating a base Gini impurity value; and
calculating a Gini gain for each of the plurality of attributes.

19. The one or more computer-readable storage media of claim 17 wherein classifying the plurality of products in the selected category into two groups comprises:
calculating a weighted cumulative rank for each product of the plurality of products based on relative rankings for each product within each performance indicator and weight values for each performance indicator.

20. The one or more computer-readable storage media of claim 17, the operations further comprising:
for each performance indicator of the one or more performance indicators:
ranking each product of the plurality of products based at least in part on the sales data;
obtaining weight values for each performance indicator; and
calculating a weighted cumulative rank for each product of the plurality of products based on the ranking and the weight values;
wherein the plurality of products are classified into the two groups based at least in part on the weighted cumulative ranks; and
wherein a threshold value is used to divide the plurality of products between the two groups based on the weighted cumulative ranks.
